(19) United States
(12) Patent Application Publication
(10) Pub. No.: US 2008/0235704 A1
(43) Pub. Date: Sep. 25, 2008

(54) Plug-and-play load balancer architecture for multiprocessor systems

(76) Inventors: Vasudev Kanduveed, Santa Clara, CA (US); Harshadrai Parekh, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/726,523

(22) Filed: Mar. 22, 2007

(51) Int. Cl. G06F 9/46

(52) U.S. Cl. 718/105

(57) ABSTRACT

One embodiment relates to a multiprocessor system with a modular load balancer. The multiprocessor system includes a plurality of processors, a memory system, and a communication system interconnecting the processors and the memory system. A kernel comprising instructions that are executable by the processors is provided in the memory system, and a scheduler is provided in the kernel. Load balancing routines are provided in the scheduler, the load balancing routines including interfaces for a plurality of balancer operations. At least one balancer plug-in module is provided outside the scheduler, the balancer plug-in module including the plurality of balancer operations. Other embodiments, aspects, and features are also disclosed.

### BACKGROUND OF THE INVENTION

1. Technical Field

The present disclosure relates to computer systems, including multiprocessor systems.

2. Description of the Background Art

Load balancing may be performed in a multiprocessor system. For example, at each load balance event, the number of processes in run-queues of each processor is examined. If the variation in the load between the processors is sufficiently high, then a process may be moved from a more highly loaded processor to a lesser loaded processor.

For example, in a multiprocessor environment, each processor may have a separate run queue. In some multiprocessor systems, once a process or thread is put on a run queue for a particular processor, it remains there until it is executed. When a process or thread is ready to be executed, it is directed to the designated processor.

In other multiprocessor systems, to keep the load on the system balanced among the processors, load balancing functionality in the core scheduler may take processes or threads waiting in a queue of one processor and move them to a shorter queue on another processor. The core scheduler is a basic part of the kernel of the operating system for the multiprocessor system.

If properly applied, load balancing may substantially improve overall performance of a multiprocessor system. However, load balancing also involves substantial overhead which can slow performance of the core scheduler and of the overall system.

It is highly desirable to improve methods and apparatus for multiprocessor systems. In particular, it is highly desirable to improve methods and apparatus for load balancing in multiprocessor systems.

### SUMMARY

One embodiment relates to a multiprocessor system with a modular load balancer. The multiprocessor system includes a plurality of processors, a memory system, and a communication system interconnecting the processors and the memory system. A kernel comprising instructions that are executable by the processors is provided in the memory system, and a scheduler is provided in the kernel. Load balancing routines are provided in the scheduler, the load balancing routines including interfaces for a plurality of balancer operations. At least one balancer plug-in module is provided outside the scheduler, the balancer plug-in module including the plurality of balancer operations.

Other embodiments, aspects, and features are also disclosed.

### BRIEF DESCRIPTION OF THE DRAWINGS

FIG. 1 is a schematic diagram of a symmetric multiprocessing (SMP) system.

FIG. 2 is a schematic diagram of a non-uniform memory architecture (NUMA) multiprocessing system.

FIG. 3 is a schematic diagram placement of balancer-related operations in a balancer plug-in that is separate from the core scheduler in accordance with an embodiment of the invention.

FIG. 4 is a schematic diagram showing plug-and-play infrastructure for a modular load balancer for use with a variety of multiprocessor system architectures in accordance with an embodiment of the invention.

### DETAILED DESCRIPTION

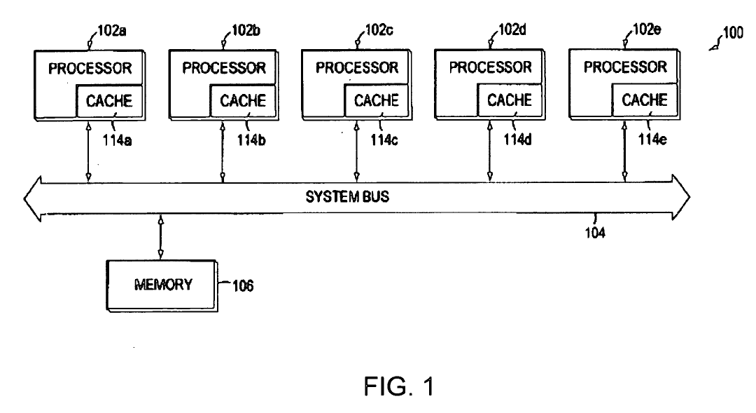

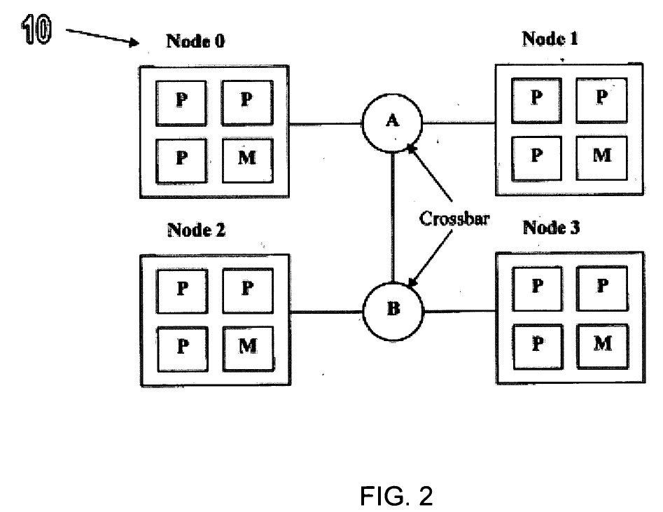

Applicants have determined that particular procedures, conditions, and algorithms for load balancing depend strongly on the architectural details of the multiprocessor system being load balanced. However, as discussed below, multiprocessor system architectures may vary greatly. For example, two different architectures are now discussed in relation to FIGS. 1 and 2.

FIG. 1 is a block diagram of a conventional symmetric multiprocessor (SMP) system 100. System 100 includes a plurality of processors 102a-e, each connected to a system bus 104. A memory 106 is also connected to the system bus 104. Each processor 102a-e can access memory 106 via the system bus 104. Each processor 102a-e typically has at least one level of cache memory 114a-e that is private to the respective processor 102a-e.

FIG. 2 is a block diagram of a Non-Uniform Memory Access (NUMA) system 10 which has four nodes. Each node includes three processors P and a memory M connected as shown. The nodes are connected to each other thru crossbar switches A and B.

Hence, as seen from FIGS. 1 and 2, the architecture for a multiprocessor system may vary greatly. In the SMP system 100 of FIG. 1, the memory 106 is accessible by each of the processors 102a-e in a “symmetric” way via the system bus 104. In contrast, in the NUMA system 10 of FIG. 2, the processor P in Node 0 can access memory M in Node 0 faster that processor in another Node (say Node 4). The difference in memory access substantially affects the specific procedures, conditions and algorithms for load balancing. Moreover, these SMP and NUMA architectures are just examples of the various potential multiprocessor architectures.

So as to deal with the wide variety of multiprocessor system architectures, load balancing code in core schedulers of operating systems for multiprocessor systems has become highly complex and cumbersome (large). The complex and cumbersome nature of the load balancing code in core schedulers provides a disadvantageously large amount of overhead which can substantially decrease performance of the overall system.

In addition to different architectures, the work load environments on the system may also place different requirements on the load balancer. For example, most work loads expect the highest responsiveness from the system expecting the kernel to distribute the work across all available processors even if all processors are not running 100% busy. On other hand, some environments may want to schedule the work load among as few a processors as possible while meeting the necessary performance criteria. The virtualization environment falls into such a category. Also, the load balancers may be required to be behave differently based on the scheduling domains. Typical variations in the load balancing functionality include the frequency of load balancing operations and the rules to migrate threads within the scheduling domain.

Plug-and-Play Load Balancer Architecture

As discussed above, applicants have identified a problematic difficulty in providing load balancing functionality in a multiprocessor operating system designed to run over various potential multiprocessor system architectures. In particular, the large differences between the various architectures (and even between systems with the same architecture) make it very cumbersome for the core scheduler to provide load balancing functionality.

Applicants have developed a solution to overcome this problematic difficulty. As described herein, the present application addresses load balancing across multiple processors using an improved software architecture which requires less overhead, while remaining applicable to various multiprocessor architectures. The improved software architecture provides a “plug-and-play” load balancer architecture, where infrastructure is provided in the core scheduler to enable load balancer plug-in modules that are tailored to specific multiprocessor systems, workload environments or customer specifications.

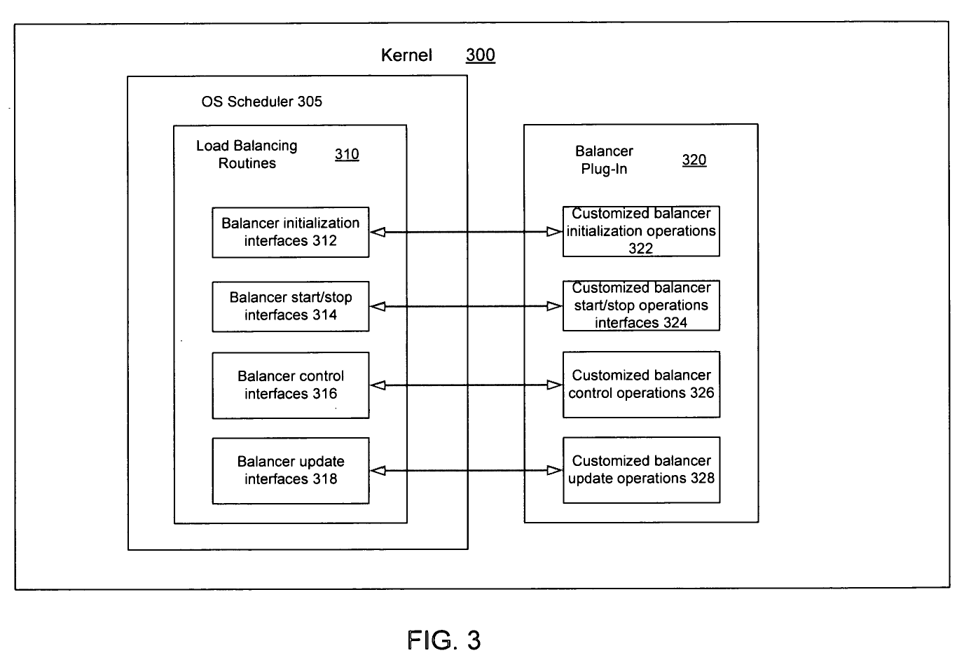

FIG. 3 is a schematic diagram placement of balancer-related operations in a balancer plug-in that is separate from the core scheduler in accordance with an embodiment of the invention. As shown, within the operating system (OS) kernel 300, there are load balancing routines 310 in the OS (core) scheduler 305. In addition, there is provided at least one balancer plug-in 320.

The load balancing routines 310 includes interfaces (e.g., 312, 314, 316, and 318) to enable plugging new load balancers into the system in a seamless manner without major changes to the OS scheduler code. Advantageously, such interfaces reduces overhead caused by overly complex and cumbersome load balancing code within the core scheduler. It also allows for making changes or enhancements to the load balancing code with little or no modification to the operating system (OS) scheduler code.

In accordance with the software architecture shown in FIG. 3, the load balancing routines 310 in the OS scheduler 305 do not deal directly with the load balancing process in that the OS scheduler code does not read or manipulate balancer data. Instead, any such accesses to balancer data occur through the use of the interfaces to the current balancer plug-in module 320.

Applicants have determined that typical balancer operations may be classified into four major categories. A first category comprises balancer initialization operations 322. A second category comprises balancer start/stop operations 324. A third category comprises balancer control operations 326. Lastly, a fourth category comprises balancer update operations 328. In accordance with an embodiment of the present invention, these four categories of operations are provided in a customized manner by software routines in the balancer plug-in module 320.

The load balancing routines 310 in the OS scheduler 305 are preferably configured to access these operations in the current balancer plug-in module 320 by way of balancer initialization interfaces 312, balancer start/stop interfaces 314, balancer control interfaces 316, and balancer update interfaces 318. By designing the core scheduler 305 with these interfaces, rather than actual code to perform the balancer operations, the code of the OS scheduler 305 may be streamlined and overhead reduced.

The following describes one particular implementation of interfaces in the OS scheduler 305 to balancer-related operations in the current balancer plug-in 320. Other similar implementations are, of course, also possible.

Balancer Initialization Interfaces

The balancer initialization interfaces 312 in the OS scheduler 305 provide access to functions such as initialization and allocation of balancer information structure. In one implementation, the balancer initialization interfaces 312 include balancer_init, balancer_alloc, and balancer_dealloc interfaces. These interfaces may perform the following functionalities.

The balancer_init (balancer initialization) interface may serve to provide access to operations related to setting up the system balancer infrastructure. Such operations may include creating a memory handle for balancer information structure allocations. This interface may be implemented, for example, so as to not require any parameters.

The balancer_alloc (balancer allocation) interface may serve to provide access for operations relating to allocating and initialization of balancer information structure. This interface may be implemented, for example, so as to accept two parameters. A first parameter (e.g., void*addr) may be used to pass the address of balancer information structure to be allocated. A second parameter (e.g., void*initval) may be used to pass in initial values for the balancer information structure.

The balancer_dealloc (balancer de-allocation) interface may serve to provide access for operations relating to de-allocating of balancer information structure. This interface may be implemented, for example, so as to accept two parameters. A first parameter (e.g., void*addr) may be used to pass the address of balancer information structure to be de-allocated. A second parameter (e.g., long flag) may be used to control the de-allocation operation. For example, a flag may be introduced to cache the balancer object, instead of freeing it.

Balancer Stop/Start Interfaces

The balancer start/stop interfaces 314 in the OS scheduler 305 provide access to functions relating to starting and stopping the load balancer. In one implementation, the balancer start/stop interfaces 314 include balancer_start, and balancer_stop interfaces. These interfaces may perform the following functionalities.

The balancer_start (balancer start) interface may serve to provide access to operations related to starting the load balancer for a scheduler entity. This interface may be implemented, for example, so as to accept two parameters. A first parameter (e.g., void*addr) may be used to pass the address of the balance information associated with the scheduler entity (for example, a sub-level domain of the multiprocessor system). A second parameter (e.g.,long flag) may be used to specify the scheduling domain for which the balancer has to be started.

The balancer_stop (balancer stop) interface may serve to provide access to operations related to stopping the load balancer for a scheduler entity. This interface may be implemented, for example, so as to accept two parameters. A first parameter (e.g., void*addr) may be used to pass the address of the balance information associated with the scheduler entity. A second parameter (e.g., long flag) may be used to specify the scheduling domain for which the balancer has to be stopped.

Balancer Control Interfaces

The balancer control interfaces 316 in the core scheduler 310 provide access to functions relating to controlling the load balancer behavior.

For example, in one implementation, there may be a specific balancer_ctl (balancer control) interface which may be used to get and set balancer attributes. This interface may be implemented, for example, so as to accept three parameters. A first parameter (e.g., void*addr) may be used to pass the address of the balance information associated with the scheduler domain. A second parameter (e.g., long command) may be used to pass command parameters (for example, to change a balancer invocation frequency). A third parameter (e.g. void*arg) may be used to pass in the data required by the command.

Balancer Update Interfaces

The balancer update interfaces 318 in the core scheduler 310 provide access to functions relating to updating the load balancer information.

For example, in one implementation, there may be a specific balancer_update (balancer update) interface which may be used to update the load balancer information when a configuration operation that affects the scheduling domain of the load balancer is initiated.

Plug-and-Play Infrastructure

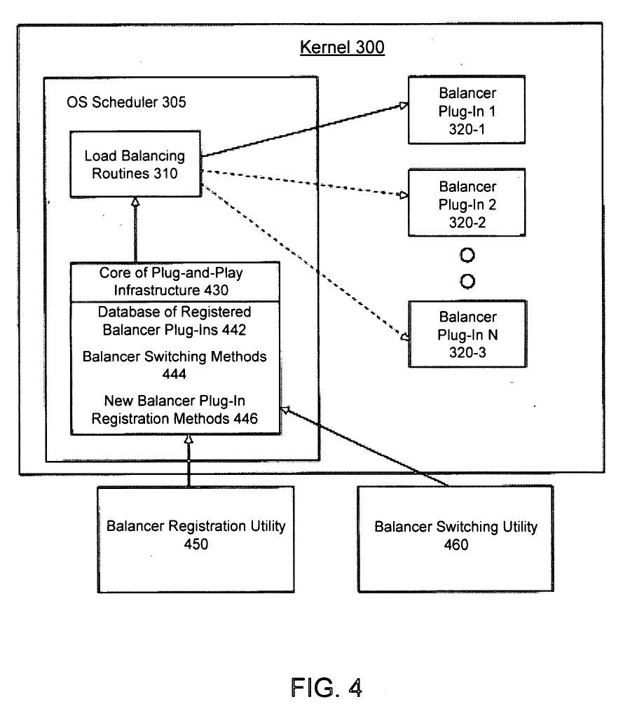

FIG. 4 is a schematic diagram showing plug-and-play infrastructure for a modular load balancer for use with a variety of multiprocessor system architectures in accordance with an embodiment of the invention. The plug-and-play infrastructure provides the facilities to dynamically add and remove new load balancers in to the kernel in a seamless manner. It also provides facilities to switch between different load balancers present in the kernel.

As shown in FIG. 4, multiple balancer plug-ins 320 may be provided. The load balancing routines 310 may be configured to currently interface with a specific one of the balancer plug-ins 320. For example, the load balancing routines 310 may currently interface with a first balancer plug-in 320-1. Subsequently, as described further below, an administrator may utilize the plug-and-play infrastructure to switch the balancer plug-in 320 being interfaced to a different one (for example, 320-2).

The core of the plug-and-play infrastructure 430 contains data structures and methods to maintain multiple load balancer implementations and to switch between the load balancer implementations on request. In particular, the data structure and methods may include a database of registered balancer plug-ins 442, balance switching methods 444, and new balancer plug-in registration methods 446.

The administrators of a system will be provided with mechanisms to register new load balancer plug-ins and to switch between different load balancer implementations. For example, registering new load balancer plug-ins may be accomplished by way of a balancer registration utility application 450, and switching between different load balancer implementations may be performed by using a balancer switching utility application 460. The balancer registration utility 450 interfaces with the new balancer plug-in registration methods 446 which in turn may access and modify the database of registered balancer plug-ins 442. The balancer switching utility 460 interfaces with the balancer switching methods 444 which in turn may also access the database of registered balancer plug-ins 442.

In accordance with an embodiment of the invention, the above-described balancer interfaces may be encapsulated using function pointers in a single operations structure (op structure). Therefore, a new load balancer may be implemented by providing, via a balancer plug-in module, appropriate customized functions for the operations in the op structure. These functions are called from appropriate places in the core scheduler code.

In the above description, numerous specific details are given to provide a thorough understanding of embodiments of the invention. However, the above description of illustrated embodiments of the invention is not intended to be exhaustive or to limit the invention to the precise forms disclosed. One skilled in the relevant art will recognize that the invention can be practiced without one or more of the specific details, or with other methods, components, etc. In other instances, well-known structures or operations are not shown or described in detail to avoid obscuring aspects of the invention. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined by the following claims, which are to be construed in accordance with established doctrines of claim interpretation.

What is claimed is:

1. A multiprocessor system with a modular load balancer, the multiprocessor system comprising:
a plurality of processors;
a memory system;
a communication system interconnecting the processors and the memory system;
a kernel comprising instructions stored in the memory system that are executable by the processors,
a scheduler in the kernel; and
load balancing routines in the scheduler, said load balancing routines including interfaces for a plurality of balancer operations; and
at least one balancer plug-in module outside the scheduler, said balancer plug-in module including the plurality of balancer operations.

2. The multiprocessor system of claim 1, wherein the balancer operations include balancer initialization operations, balancer start/stop operations, balancer control operations, and balancer update operations.

3. The multiprocessor system of claim 2, wherein the balancer initialization operations include operations for allocation and de-allocation of balancer information structure.

4. The multiprocessor system of claim 2, wherein the balancer start/stop operations include operations to start and stop load balancing for a scheduler entity.

5. The multiprocessor system of claim 2, wherein the balancer control operations include operations to get and set balancer attributes.

6. The multiprocessor system of claim 1, further comprising a balancer switching utility which is configured to switch between balancer plug-in modules by using balancer switching methods in the scheduler.

7. The multiprocessor system of claim 1, further comprising a balancer registration utility which is configured to register balancer plug-in modules by using balancer plug-in registration methods in the scheduler.

8. The multiprocessor system of claim 1, further comprising a database of registered balancer plug-ins in the scheduler.

9. A method of load balancing for a multiprocessor system, the method comprising:
executing load balancing routines a scheduler in a kernel of an operating system for the multiprocessor system; and
utilizing balancer interfaces by the load balancing routines so as to access load balancing operations in a balancer plug-in module outside the scheduler.

10. The method of claim 9, wherein the balancer interfaces include interfaces for balancer initialization operations, balancer start/stop operations, balancer control operations, and balancer update operations, and wherein the load balancing operations include the balancer initialization operations, the balancer start/stop operations, the balancer control operations, and the balancer update operations.

11. The method of claim 10, wherein the balancer initialization operations include operations for allocation and de-allocation of balancer information structure.

12. The method of claim 10, wherein the balancer start/stop operations include operations to start and stop load balancing for a scheduler entity.

14. The method of claim 10, wherein the balancer control operations include operations to get and set balancer attributes.

15. The method of claim 9, further comprising switching between balancer plug-in modules using balancer switching methods in the scheduler.

16. The method of claim 9, further comprising registering a new balancer plug-in module using registration methods in the scheduler.

17. An apparatus for load balancing in a multiprocessor system, the apparatus comprising:
a kernel of an operating system for the multiprocessor system, the kernel including a core scheduler having load balancing interfaces; and
a load balancing plug-in module with customized load balancing operations which are accessed by the core scheduler via the load balancing interfaces,
wherein the load balancing interfaces include interfaces for balancer initialization operations, balancer start/stop operations, and balancer control operations, and
wherein the load balancing operations include the balancer initialization operations, the balancer start/stop operations, and the balancer control operations.

18. The apparatus of claim 17, further comprising plug-and-play infrastructure in the kernel which is configured to enable switching between load balancing plug-in modules.

19. The apparatus of claim 18, wherein the plug-and-play infrastructure is further configured to enable registering new load balancing plug-in modules.

20. The apparatus of claim 19, wherein the plug-and-play infrastructure further includes a database of registered load balancing plug-in modules.
